(19) United States
(12) Patent Application Publication
(10) Pub. No.: US 2026/0217201 A1
(43) Pub. Date: Jul. 30, 2026

(54) REAR VIEW ASSEMBLY FOR A VEHICLE AND VEHICLE

(71) Applicant: Motherson Innovations Company Limited, London (GB)

(72) Inventor: Gary Sinelli, Birmingham, MI (US)

(21) Appl. No.: 19/457,408

(22) Filed: Jan. 23, 2026

(30) Foreign Application Priority Data
Jan. 24, 2025 (DE) 102025102542.8

(51) Int. Cl. B60R 11/04; B60R 1/25; B60R 1/26; B60R 11/00

(52) U.S. Cl. CPC B60R 11/04; B60R 1/25; B60R 1/26; B60R 2011/004

(57) ABSTRACT

A rear view assembly for a vehicle, the rear view assembly comprising a camera arm comprising a mounting interface for pivotably coupling the rear view assembly to a vehicle body, a camera arranged on the camera arm and configured to capture a rear view or a side view of the vehicle. The rear view assembly further comprising, a cover for the camera arm and a reflective unit arranged to move between an exposed position and a retracted position. The reflective unit may move through an opening formed on a surface of the cover. The reflective unit may be deployed in the event of a camera system failure, providing a great benefit for the safety of a driver and other vehicles on the road.

### CROSS-REFERENCE TO RELATED APPLICATIONS

This application claims priority to German Patent Application No. DE 10 2025 102 542.8, filed on Jan. 24, 2025, the entire contents of which are hereby incorporated by reference.

### BACKGROUND

The present disclosure relates to a rear view assembly for a vehicle. The present disclosure also relates to a vehicle comprising such a rear view assembly.

Generally, motor vehicles have a pair of external rear view mirrors placed on either side of the vehicle to obtain a view on the sides and rear of the vehicle. Further, it is observed in various developments that mirrors are being replaced with a vision system or cameras, mounted as a standalone fixture to capture a field of view to the sides and rear of a vehicle. However, when the ability to view the sides and rear of the vehicle are solely dependent on a camera system and the camera system fails, has a malfunction, or is otherwise inoperable it creates a problem for the driver of the vehicle to be able to see behind them.

Therefore, there is a pressing need for an innovative approach in rear view assemblies for vehicles. Such a solution would incorporate the use of a mirror that is hidden within the arm of a rear view assembly. The hidden mirror would be inconspicuous to the untrained eye, and the aesthetics of the arm would not be altered. However, in the event of a camera system failure, the hidden mirror could be deployed to enable the driver to have a portion of the side and the rear of the vehicle to be visible. The present disclosure provides a rear view system that overcomes the problem of a camera system failure.

### SUMMARY

In an embodiment, the present disclosure describes a rear view assembly for a vehicle. The rear view assembly comprises a camera arm, a camera, a cover for the camera arm and a reflective unit. The camera arm comprises a mounting interface for pivotably coupling the rear view assembly to a vehicle body. The camera is arranged on the camera arm and configured to capture a rear view or a side view of the vehicle. The reflective unit is arranged to move between an exposed position and a retracted position. The reflective unit may move through an opening formed on a surface of the cover. A reflective unit that may be deployed for additional safety of the vehicle, such as in the event of a camera system failure, enhances the safety of a driver and other vehicles on the road.

In another embodiment, the reflective unit may comprise an outer surface configured to cover the opening and to match with the surface of the cover in the retracted position of the reflective unit. Additionally, a projected surface may have a reflective element or reflective coating that is configured to provide the rear view or side view of the vehicle in the exposed position of the reflective unit. The aesthetics of the camera arm are not negatively impacted by this design. The reflective unit may only be noticeable when in the exposed position.

In yet another embodiment, the reflective element is a mirror or a chrome finish material, and the reflective coating is a chrome coating. Having a reflective element that may take many shapes or forms but still provides a driver with a view of his surroundings is particularly beneficial.

In a further embodiment, the reflective unit is pivotably coupled with the camera arm to enable movement between the exposed position and the retracted position. The reflective unit being pivotably coupled with the camera arm allows the reflective unit to stay hidden in the retracted position and to be visible in the exposed position.

In yet a further embodiment, the rear view assembly may further comprise a control mechanism that is configured to enable smooth movement of the reflective unit from the retracted position to the exposed position and to hold the reflective unit at the exposed position.

In another embodiment, the control mechanism comprises at least one of a spring, a damping material, a hydraulic actuator, and an electrical actuator. There are many ways for the control mechanism to be configured. The above mentioned forms would all achieve a smooth movement of the reflective unit from the retracted position to the exposed position.

In yet another embodiment, the rear view assembly may further comprise a locking mechanism configured to lock the reflective unit in the retracted position.

In a further embodiment, the locking mechanism is configured to be manually and/or electrically operated. In yet a further embodiment, the locking mechanism may comprise a latch device, a push lock, a magnetic lock, and/or an electrically actuated lock. Having the option for the driver to manually employ the reflective unit upon camera malfunction detection is very reliable. Further, the magnetic lock and the electrically actuated lock may automatically move the reflective unit from the retracted position to the exposed position and vice versa.

In another embodiment, the rear view device may further comprise an Electronic Control Unit (ECU) configured to receive data from the camera, analyze the received data, detect improper data within the analyzed data, and actuate the locking mechanism for moving the reflective unit to the exposed position upon detection of improper data from the camera. The ECU may alert the driver that the cameras have malfunctioned and automatically move the reflective unit from the retracted position to the exposed position.

In yet another embodiment, the improper data from the camera is caused by at least one of a malfunction of the camera, dirt deposition on a lens of the camera, and water deposition on a lens of the camera.

In a further embodiment, the ECU may be further configured to automatically move the reflective unit to the retracted position once detecting folding of the rear view assembly. Generally, the driver needs to view the rear view or side view only while driving the vehicle and therefore in case the rear view assembly is folded, the reflective unit may also not be required to be in the exposed position.

In a further embodiment, the ECU may be further configured to automatically move the reflective unit to the exposed position once detecting folding of the rear view assembly. If the projected surface is directed towards the rear of the vehicle when the rear view assembly is folded, then the driver may move the reflective unit into the exposed position by folding the rear view assembly.

In another embodiment, the present disclosure describes the vehicle comprising at least one rear view assembly according to the present disclosure.

In the aforementioned embodiments there are advantages over the prior art of the rear view assembly such as having a reflective unit that can be deployed in the event of a camera system failure which enhances the safety of a driver and other vehicles on the road. In a retracted position, the reflective unit may not negatively impact aesthetics of the camera arm, and the reflective unit will only be noticeable when in the exposed position. Having the option for the driver to manually employ the reflective unit upon camera malfunction detection is very reliable. However, also having the ECU able to detect a malfunction of the camera system and automatically move the reflective unit from the retracted position to the exposed position adds another advantage.

The foregoing summary, as well as the following detailed description, will be better understood when read in conjunction with the appended drawings. For the purpose of illustration, certain examples of the present description are shown in the drawings. It should be understood, however, that the disclosure is not limited to the precise arrangements and instrumentalities shown. The accompanying drawings, which are incorporated in and constitute a part of this specification, illustrate an implementation of system, apparatuses, and methods consistent with the present description and, together with the description, serve to explain advantages and principles consistent with the disclosure. The figures are not necessarily drawn to scale. Like numbers used in the figures refer to like components. However, it will be understood that the use of a number to refer to a component in a given figure is not intended to limit the component in another figure labelled with the same number.

### BRIEF DESCRIPTION OF THE DRAWINGS

Other aspects, advantages, and salient features of the present disclosure will become apparent to those skilled in the art from the following detailed description disclosing one or more embodiments of the present disclosure by way of example only, which taken in conjunction with the annexed drawings, discloses exemplary embodiments of the disclosure, wherein:

FIG. 1 illustrates a perspective view of a rear view assembly according to an embodiment of the present disclosure;

FIG. 2 illustrates a perspective view of a reflective unit in a retracted position according to an embodiment of the present disclosure;

FIG. 3 illustrates a perspective view of the reflective unit in an exposed position according to an embodiment of the present disclosure;

FIG. 4 illustrates a cross-sectional view of the reflective unit in the exposed position according to an embodiment of the present disclosure; and

FIG. 5 illustrates a front perspective view of the reflective unit in the exposed position according to an embodiment of the present disclosure.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

It is to be understood that the phraseology and terminology employed herein are for the purpose of description and should not be regarded as limiting. For example, the use of a singular term, such as, “a” is not intended as limiting of the number of items. Also, the use of relational terms, such as but not limited to, “top,” “bottom,” “left,” “right,” “upper,” “lower,” “down,” “up,” and “side,” are used in the description for clarity and are not intended to limit the scope of the disclosure or the appended claims. Further, it should be understood that any one of the features can be used separately or in combination with other features. Other systems, methods, features, and advantages of the disclosure will be or become apparent to one with skill in the art upon examination of the detailed description. It is intended that all such additional systems, methods, features, and advantages be included within this description, be within the scope of the present disclosure, and be protected by the accompanying claims.

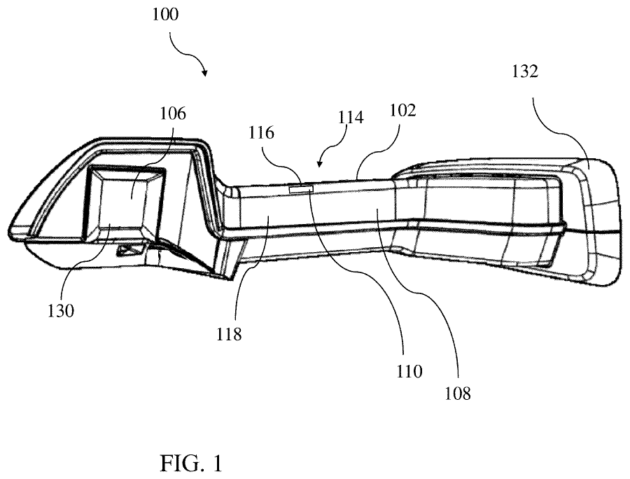

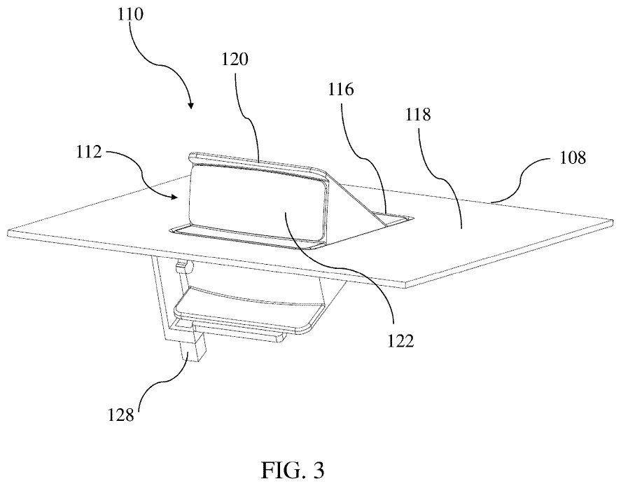

FIG. 1 illustrates a perspective view of a rear view assembly 100. The rear view assembly 100 may comprise a camera arm 102 comprising a mounting interface (not shown) for pivotably coupling the rear view assembly 100 to a vehicle body (not shown). The rear view device may further comprise a camera 106 arranged on the camera arm 102 and configured to capture a rear view or a side view of the vehicle. The rear view assembly 100 further comprising, a cover 108 for the camera arm 102 and a reflective unit 110 arranged to move between an exposed position 112 (see FIG. 3) and a retracted position 114. The reflective unit 110 may move through an opening 116 formed on a surface 118 of the cover 108.

FIG. 1 further illustrates that the camera arm 102 may by mounted to a base 132 to be attached to a body of the vehicle. Additionally, the camera 106 may have a lens 130 to be attached to the camera arm 102.

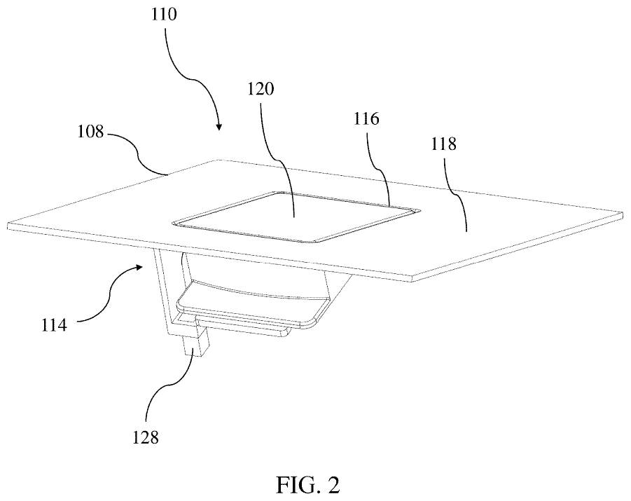

FIG. 2 illustrates a perspective view of a reflective unit 110 in a retracted position 114. The reflective unit 110 may comprise an outer surface 120 configured to cover the opening 116 and to match with the surface 118 of the cover 108 in the retracted position 114 of the reflective unit 110. The retracted position 114 would be observed when the camera 106 would be functioning as designed. The opening 116 would be minimally visible and not detract from the aesthetic appearance of the camera arm 102. The outer surface 120 of the reflective unit 110 may be configured to fit near seamlessly into the opening 116. As shown, the rear view assembly 100 may further comprise a locking mechanism 128 configured to lock the reflective unit 110 in the retracted position 114. The locking mechanism 128 may be configured to be manually and/or electrically operated. Furthermore, the locking mechanism 128 may comprise a latch device, a push lock, a push-push lock, a magnetic lock, and/or an electrically actuated lock. A driver of the vehicle may manually employ the reflective unit 110 by any of a latch device, a push lock, or a push-push lock. Further, the magnetic lock and the electrically actuated lock may automatically move the reflective unit from the retracted position to the exposed position and vice versa.

FIG. 3 illustrates a perspective view of the reflective unit 110 in an exposed position 112. The reflective unit 110 may comprise a projected surface 122 having a reflective element or a reflective coating. The reflective element may be a mirror or a chrome finish material, and the reflective coating may be a chrome coating. The reflective unit 110 in the exposed position 112 shows the projected surface 122 that is configured to provide the rear view or side view of the vehicle to the driver. The projected surface 122 may be miniature in size to only aid visibility in emergencies caused by failure of the camera 106. The projected surface 122 may be made of glass or plastic with a reflective coating applied thereto. The projected surface 122 may be of a convex shape or may have a variable radius in the range of 100 mm to 250 mm. The convex shape of the projected surface 122 may be a curved mirror that bulges outward and reflects light away from the mirror. The projected surface 122 may be at least a partial spherical mirror. The convex mirror may have a pole that is the central point on the spherical mirror. It is a midpoint of the mirror's reflective surface and is located on a principal axis. The principal axis is an imaginary line passing through a center of curvature and the pole of a spherical mirror. It serves as a reference line for describing the geometry of the mirror. The center of curvature may be the central point along the principal axis of the spherical mirror. The central point of the projected surface 122 may be aimed generally in a direction towards the rear of the vehicle along the principal axis from about −12 degrees to 12 degrees in all directions. The projected surface 122 may have a size of 40 mm to 100 mm wide and 20 mm to 50 mm tall. An optimal size of the projected surface 122 may be 60 mm wide and 26 mm tall. This small size allows for the projected surface 122 to be easily hidden within the camera arm 102 but also big enough to be effectively used to view the side and rear of the vehicle.

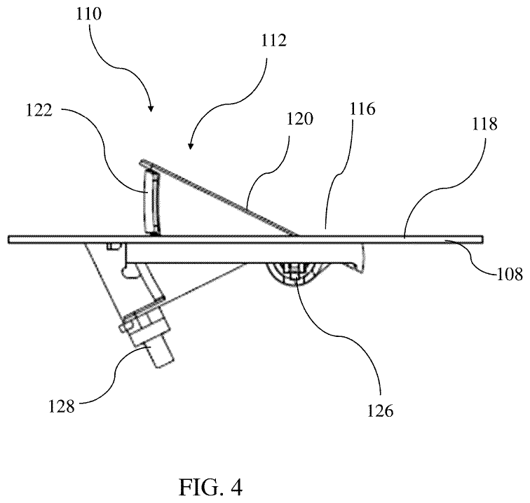

FIG. 4 illustrates a cross-sectional view of the reflective unit 110 in the exposed position 112. The reflective unit 110 may be pivotably coupled with the camera arm 102 (see FIG. 1) to enable movement from the exposed position 112 to the retracted position 114 and vice versa. Further, the reflective unit 110 comprises a control mechanism 126. The control mechanism 126 may be configured to enable smooth movement of the reflective unit 110 from the retracted position 114 to the exposed position 112 and to hold the reflective unit 110 in the exposed position 112. The control mechanism 126 may be selected from a spring, a damping material, a hydraulic actuator, an electrical actuator, and combinations thereof.

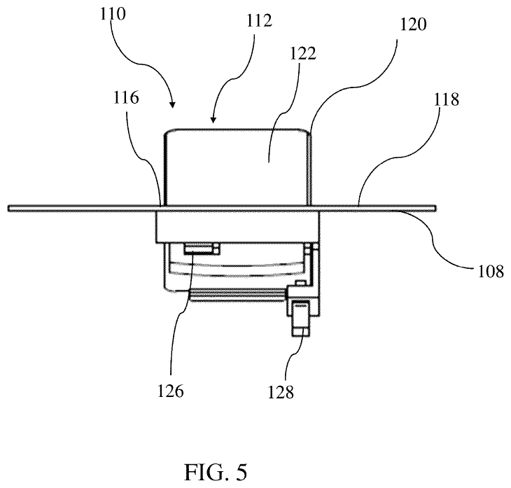

FIG. 5 illustrates a front perspective view of the reflective unit 110 in the exposed position 112. As shown, the reflective unit 110 in the exposed position 112 shows the projected surface 122 directed towards rear of the vehicle and the outer surface 120 of the reflective unit 110 directed substantially towards front of the vehicle. The reflective unit 110 projects in an upward or outward direction through the opening 116. Beneath the surface 118, the control mechanism 126 and the locking mechanism 128 are visible.

In an example, the rear view assembly 100 may further comprise an Electronic Control Unit (ECU) configured to receive data from the camera 106, analyze the received data, detect improper data within the analyzed data, and actuate the locking mechanism 128 for moving the reflective unit 110 to the exposed position 112 upon detection of improper data from the camera 106. The improper data from the camera 106 may be caused by at least one of a malfunction of the camera 106, debris deposited on a lens 130 of the camera 106, and water deposited on the lens 130 of the camera 106. The ECU may be further configured to automatically move the reflective unit 110 from the exposed position 112 to the retracted position 114 once detecting folding of the rear view assembly 100. Generally, the driver needs to view the rear view or side view only while driving the vehicle. Therefore, in case the rear view assembly 100 is folded, the reflective unit 110 may also not require to be in the exposed position. However, the ECU may be further configured to automatically move the reflective unit 110 from the retracted position 114 to the exposed position 112 once detecting folding of the rear view assembly 100. If the projected surface 122 is directed towards the rear of the vehicle when the rear view assembly 100 is folded, then the driver may move the reflective unit into the exposed position 112 by folding the rear view assembly 100.

The vehicle may be configured with at least one rear view assembly 100 according to the present disclosure.

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

Furthermore, the features of the disclosure disclosed in this specification, the claims, and the drawings may be employed both individually and in any possible combination for practicing the disclosure in its various exemplary embodiments. In particular, all claim feature combinations, irrespective of the claim dependencies, are covered with this application.

### LIST OF NUMBERS

100 rear view assembly
102 camera arm
106 camera
108 cover
110 reflective unit
112 exposed position
114 retracted position
116 opening
118 surface
120 outer surface
122 projected surface
126 control mechanism
128 locking mechanism
130 lens
132 base

What is claimed is:

1. A rear view assembly for a vehicle, the rear view assembly comprising:
a camera arm comprising a mounting interface for pivotably coupling the rear view assembly to a vehicle body;
a camera arranged on the camera arm and configured to capture a rear view or a side view of the vehicle;
a cover for the camera arm; and
a reflective unit arranged to move between an exposed position and a retracted position through an opening formed on a surface of the cover.

2. The rear view assembly of claim 1, wherein the reflective unit comprises:
an outer surface configured to cover the opening and to match with the surface of the cover in the retracted position of the reflective unit; and
a projected surface having a reflective element or a reflective coating that is configured to provide the rear view or the side view of the vehicle in the exposed position of the reflective unit.

3. The rear view assembly of claim 2, wherein the reflective element is a mirror or a chrome finish material.

4. The rear view assembly of claim 2, wherein the reflective coating is a chrome coating.

5. The rear view assembly of claim 1, wherein the reflective unit is pivotably coupled with the camera arm to enable movement between the exposed position and the retracted position.

6. The rear view assembly of claim 1, further comprising a control mechanism that is configured to enable smooth movement of the reflective unit from the retracted position to the exposed position and to hold the reflective unit at the exposed position.

7. The rear view assembly of claim 6, wherein the control mechanism comprises at least one of a spring, a damping material, a hydraulic actuator, and an electrical actuator.

8. The rear view assembly of claim 1, further comprising a locking mechanism configured to lock the reflective unit in the retracted position.

9. The rear view assembly of claim 8, wherein the locking mechanism is configured to be manually operated.

10. The rear view assembly of claim 8, wherein the locking mechanism is configured to be electrically operated.

11. The rear view assembly of claim 8, wherein the locking mechanism comprises at least one of a latch device, a push lock, a magnetic lock, and an electrically actuated lock.

12. The rear view assembly of claim 1, further comprising an Electronic Control Unit (ECU) configured to:
receive data from the camera,
analyze the received data;
detect improper data within the analyzed data; and
actuate the locking mechanism for moving the reflective unit to the exposed position upon detection of improper data from the camera.

13. The rear view assembly of claim 12, wherein the improper data from the camera is caused by at least one of a malfunction of the camera, dirt deposition on a lens of the camera, and water deposition on a lens of the camera.

14. The rear view assembly of claim 12, wherein the ECU is further configured to automatically move the reflective unit to the retracted position upon detecting folding of the rear view assembly.

15. The rear view assembly of claim 12, wherein the ECU is further configured to automatically move the reflective unit to the exposed position upon detecting folding of the rear view assembly.

16. A vehicle comprising:
a rear view assembly, the rear view assembly comprising:
a camera arm comprising a mounting interface for pivotably coupling the rear view assembly to a vehicle body;
a camera arranged on the camera arm and configured to capture a rear view or a side view of the vehicle;
a cover for the camera arm; and
a reflective unit arranged to move between an exposed position and a retracted position through an opening formed on a surface of the cover.
